(19) United States
(12) Patent Application Publication
(10) Pub. No.: US 2023/0184301 A1
(43) Pub. Date: Jun. 15, 2023

(54) MAGNETO-RHEOLOGICAL BRAKE ASSEMBLY

(71) Applicant: Xuan Hung NGUYEN, Ho Chi Minh City (VN)

(72) Inventors: Quoc Hung NGUYEN, Ho Chi Minh City (VN); Xuan Hung NGUYEN, Ho Chi Minh City (VN)

(21) Appl. No.: 17/550,061

(22) Filed: Dec. 14, 2021

(51) Int. Cl. F16D 57/00; F16D 57/02

(52) U.S. Cl. CPC F16D 57/002; F16D 57/02; F16D 2121/20

(57) ABSTRACT

Disclosed herein is an MR brake assembly comprising a driven member comprising a rotor defining an outward face, a brake housing defining a chamber for accommodating the rotor therein, the brake housing defining an inward face, and a quantity of MR fluid disposed in the chamber. The MR brake assembly further comprises annular structures with each thereof having a medial diameter that differs from the medial diameter of another one of the plurality of annular structures, each of the rotor and the brake housing having at least one of the plurality of annular structures one of formed therewith and coupled thereto adjacent the corresponding one of the inward face and the outward face. A magnetic field generation assembly configured to selectively apply a magnetic field to the quantity of MR fluid for controlling engagement of the rotor with the brake housing to brake the driven member.

### TECHNICAL FIELD

The present invention relates generally to a magneto-rheological brake assembly.

### BACKGROUND

One of the ways to slow or stop a vehicle in motion is through the use of brakes. Typically, two types of brakes found in conventional vehicles, namely, oil brakes and mechanical brakes. Each type of brake has different design and usage characteristics. Traditional mechanical brakes use brake pads which are operated by a mechanism of direct transmission from a hand lever or foot pedal to the brake pads. Displacing the brake pads to a brake housing increases friction, thereby reducing the speed of the vehicle. On the contrary, oil brakes use a hydraulic piston system. When a user operates a brake pedal or lever, the hydraulic system will squeeze a brake disc between two brake pads to reduce the speed. Both types of brakes use friction mechanisms between the brake pads and the brake discs or brake housing to slow a vehicle down which has a consequence of high wear and being noisy.

The introduction of and the research and development into magneto-rheological fluids (MRF) have created opportunities to developing new types of brakes not only for cars and motorcycles but also for many other applications with a view of overcoming the disadvantages of traditional brakes. MRF-based brakes (MRB) have been researched and applied widely all over the world, including to some of the typical brakes such as disc brakes, drum brakes, T-disc brakes, and brakes with side coils. It has been found that MRB has many outstanding features and advantages compared to existing brake with the research and application of MRB concluding that MRBs are highly feasible and in accordance with the actual conditions and needs today.

There have been several studies into the shape and configuration of MRBs with a view to optimizing braking performance. The first few designs of MRB uses the disc brake configuration which has the advantage of being easy to fabricate while achieving optimal results in terms of weight and dimensions. However, installation of components on disc brakes is and the disc of disc brakes are long and small.

Drum brake configuration was considered to be able to overcome the disadvantages of disc brake configuration because the braking force is generated on the inner cylindrical surface of the drum. However, the configuration results in quite large moment of inertia being generated when in use. To overcome this problem, an inverted drum shape was proposed to reduce the moment of inertia.

To overcome the disadvantages of drum brake and disc brake configurations, a hybrid brake configuration combining the braking action of both the drum brake and the disc brake may be implemented. In fact, research has shown that hybrid brakes are operationally more optimal. In order to further optimize the performance of hybrid brakes, hybrid brakes with 2 coils and hybrid brake with a T-shaped rotor section were studied. However, the actual mass and dimensions of the results of these studies have not changed significantly. Hence, we need an approach to increase the brake moment and while reducing its volume and size for MRBs.

### SUMMARY

In accordance with a first aspect of the invention, there is disclosed a magneto-rheological (MR) brake assembly comprising a driven member rotatable about a drive axis and comprising a rotor defining an outward face, a brake housing defining a chamber being shaped and dimensioned for accommodating the rotor therein, the brake housing defining an outward face opposing the inward face of the rotor, and a quantity of MR fluid disposed in the chamber. The MR brake assembly further comprises a plurality of annular structures, each of the plurality of annular structures having a medial diameter that differs from the medial diameter of another one of the plurality of annular structures, each of the rotor and the brake housing having at least one of the plurality of annular structures one of formed therewith and coupled thereto adjacent the corresponding one of the inward face and the outward face. The MR brake assembly also comprises a magnetic field generation assembly configured to selectively apply a magnetic field to the quantity of MR fluid for controlling engagement of the rotor with the brake housing to brake the driven member, wherein each of the plurality of annular structures is made from magnetic material with the plurality of annular structures being spatially inter-displaced.

In accordance with a second aspect of the invention, there is disclosed a magneto-rheological (MR) brake assembly comprising a driven member rotatable about a drive axis and comprising a rotor defining two outward faces, a brake housing defining a chamber being shaped and dimensioned for accommodating the rotor therein, the brake housing defining two outward faces opposing the two inward faces of the rotor when the rotor is received within the chamber, and a quantity of MR fluid disposed in the chamber. The MR brake assembly further comprises a first plurality of annular structures, each of the first plurality of annular structures having a medial diameter that differs from the medial diameter of another one of the first plurality of annular structures, each of one of the two outward faces and the corresponding one of the two inward faces having at least one of the first plurality of annular structures one of formed therewith and coupled thereto. The MR brake assembly further comprises a second plurality of annular structures, each of the second plurality of annular structures having a medial diameter that differs from the medial diameter of another one of the second plurality of annular structures, each of the other of the two outward faces and the corresponding the other of the two inward faces having at least one of the second plurality of annular structures one of formed therewith and coupled thereto. The MR brake assembly also comprises a magnetic field generation assembly configured to selectively apply a magnetic field to the quantity of MR fluid for controlling engagement of the rotor with the brake housing to brake the driven member, wherein each of the first plurality of annular structures is made from magnetic material and being spatially inter-displaced and each of the second plurality of annular structures is made from magnetic material and being spatially inter-displaced.

### BRIEF DESCRIPTION OF THE DRAWINGS

For a better understanding of the present disclosure, non-limiting and non-exhaustive embodiments are described in reference to the following drawings. In the drawings, like reference numerals refer to parts through all the various figures unless otherwise specified.

FIG. 1 shows a partial front sectional view of a magneto-rheological (MR) brake configuration according to an aspect of the invention;

FIG. 2 shows a B-H characteristic curve of a quantity of MR fluid, specifically MRF 132-DG, utilized in the MR brake assembly of FIG. 1;

FIG. 3 shows a B-H characteristic curve of a magnetic material, specifically C45 steel, used for forming the first plurality of annular structures and a second plurality of annular structures of the MR brake assembly of FIG. 1 for configured for generating first and second zig-zag flux lines;

FIG. 4 shows a front sectional finite element (FE) based magnetic analysis of the MR brake assembly with first and second zig-zag flux lines;

FIG. 5 shows a partial front cut-away view of the MR brake assembly of FIG. 1;

FIG. 6 shows a partial perspective cut-away view of the MR brake assembly of FIG. 1; and

FIG. 7 shows a partial system diagram of a magnetic field generation assembly utilized in the MR brake assembly of FIG. 1.

### DETAILED DESCRIPTION

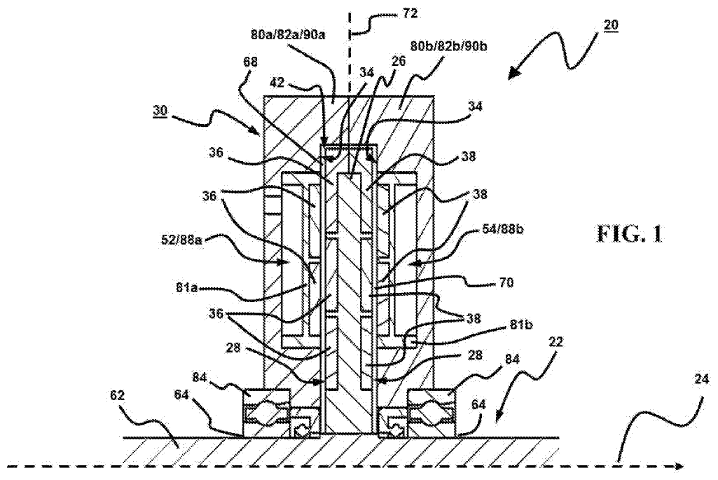

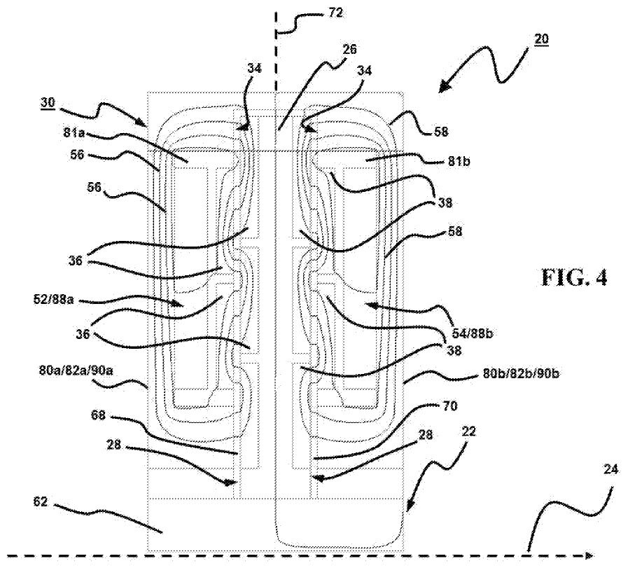

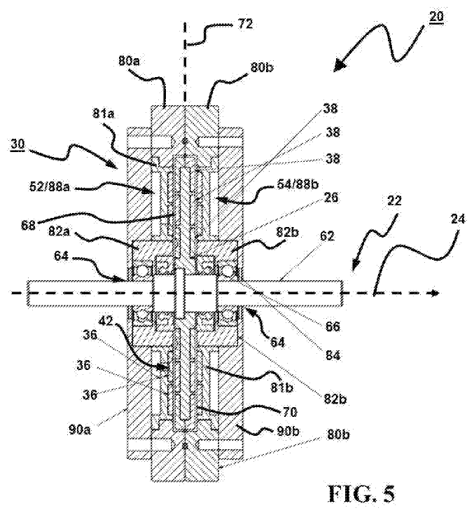

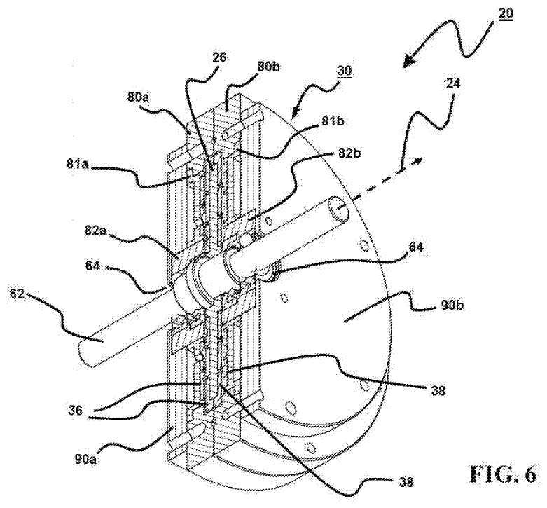

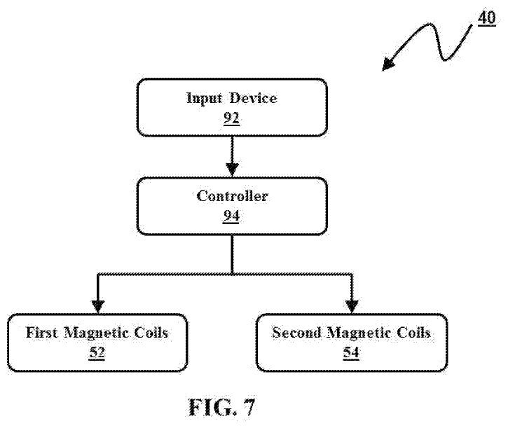

An exemplary embodiment of the present invention, a magneto-rheological (MR) brake assembly 20, is described hereinafter with reference to FIG. 1 to FIG. 7.

The MR brake assembly 20 comprises a driven member 22 rotatable about a drive axis 24.

The driven member 22 comprises a rotor 26 defining two outward faces 28. The two outward faces 28 outwardly opposes one another. The MR brake assembly 20 further comprises a brake housing 30 defining a chamber being shaped and dimensioned for accommodating the rotor 26, or at least a portion thereof, therein. The brake housing 30 defining two inward faces 34 with each of the two outward faces 28 opposing a corresponding one of the two inward faces 34 of the rotor 26 when the rotor 26 is received within the chamber.

The MR brake assembly 20 further comprises a first plurality of annular structures 36. Each of the first plurality of annular structures 36 having a medial diameter that differs from the medial diameter of another one of the first plurality of annular structures 36. Each of one of the two outward faces 28 and the corresponding one of the two inward faces 34 having at least one of the first plurality of annular structures 36 one of formed therewith and coupled thereto. The MR brake assembly 20 further comprises a second plurality of annular structures 38, each of the second plurality of annular structures 38 having a medial diameter that differs from the medial diameter of another one of the second plurality of annular structures 38. Each of the other of the two outward faces 28 and the corresponding the other of the two inward faces 34 having at least one of the second plurality of annular structures 38 one of formed therewith and coupled thereto.

The MR brake assembly 20 also comprises a magnetic field generation assembly 40 configured to selectively apply a magnetic field to a quantity of MR fluid 42 disposable in the chamber for controlling engagement of the rotor 26 with the brake housing 30 to brake the driven member 22. Each of the first plurality of annular structures 36 and each of the second plurality of annular structures 38 are made from magnetic material. The first plurality of annular structures 36 being inter-displaced and the second plurality of annular structures 38 being spatially inter-displaced.

Preferably, one portion of each of the first plurality of annular structures 36 and the second plurality of annular structures 38 are arranged concentrically about the drive axis 24 along the corresponding one of the two inward faces 34 of the brake housing 30 while the other portion of each of the first plurality of annular structures 36 and the second plurality of annular structures 38 being arranged concentrically about the drive axis 24 along the corresponding one of the two outward faces 28 of the rotor 26. Each of the two inward faces 34 and the two outward faces 28 are substantially planar and perpendicular the drive axis 24.

In one implementation of the MR brake assembly 20, the brake housing 30 may comprise a first disc spatially displaced from the one portion of the first plurality of annular structures 36 arranged along one of the two inward faces 34. The first disc is dimensioned to be diametrically nearest to a diametrically largest one of the one portion of the first plurality of annular structures 36 arranged along the other of the two inward faces 34. The brake housing 30 also comprises a second disc spatially displaced from the one portion of the second plurality of annular structures 38 arranged along the other of the two inward faces 34. The second disc is dimensioned to be diametrically nearest to a diametrically largest one of the one portion of the second plurality of annular structures 38 arranged along the other of the two inwards face 34. Each of the first disc and the second disc is made from magnetic material.

In the one implementation of the MR brake assembly 20 with the first disc and the second disc, the brake housing 30 may further comprise a first flange and a second flange. The first flange extends from the circumferential periphery of the first disc and terminating adjacent the diametrically largest one of the one portion of the first plurality of annular structures 36 arranged along one of the two inward faces 34. The second flange extending from the circumferential periphery of the second disc and terminating adjacent the diametrically largest one of the one portion of the second plurality of annular structures 38 arranged along the other of the two inward faces 34.

Preferably, the magnetic field generation assembly 40 comprises at least one first magnetic coil 52 disposed between the first disc and the one portion of the first plurality of annular structures 36 arranged along one of the two inward faces 34, and at least one second magnetic coil 54 disposed between the second disc and the one portion of the second plurality of annular structures 38 arranged along the other of the two inward faces 34.

Preferably, the side planar cross-sectional position of the one portion of the first plurality of annular structures 36 along one of the two inward faces 34 being radially staggered from the side planar cross-sectional position of the other portion of the first plurality of annular structures 36 along one of the two the outward faces 38 to define a first zig-zag flux lines 56 therebetween. The side planar cross-sectional position of the one portion of the second plurality of annular structures 38 along the other of the two inward faces 34 being radially staggered from the side planar cross-sectional position of the other portion of the second plurality of annular structures 38 along the other of the two outward faces 38 to define a second zig-zag flux lines 58 therebetween.

Preferably, the side planar cross-section being defined along a plane parallel the drive axis 24, and the quantity of MR fluid 42 being a controllable medium having a rheology variable response to changes in magnetic field generated by the magnetic field generation assembly 40 for controllably resisting rotation of the rotor 26, and consequently resisting rotation of the driven member 22, about the drive axis 24.

The driven member 22 further comprises a shaft 62 whereto the rotor 26 is coupled. The shaft 62 extends along the drive axis 24 and out of a pair of apertures 64 defined by the brake housing 30. The brake housing 30 comprises a pair of seals 66 disposed adjacent the pair of apertures 64 for substantially fluid sealing the shaft 62 with the brake housing 30 at the pair of apertures 64. Preferably, the magnetic material is C45 steel.

Preferably, the rotor 26 is positioned within the chamber for defining a first fluid slot 68 between one of the two inward faces 34 of the brake housing 30 and one of the two outward faces 28 of the rotor 26 to enable the quantity MR fluid 42 in the chamber to interface the one portion of the first plurality of annular structures 36 and the other portion of the first plurality of annular structures 36. A second fluid slot 70 is defined between the other of the two inward faces 34 of the brake housing 30 and the other of the two outward faces 28 of the rotor 26 enable the quantity MR fluid 42 in the chamber to further interface the one portion of the second plurality of annular structures 38 and the other portion of the second plurality of annular structures 38.

Preferably, the quantity of MR fluid 40 has properties that are shown in Table 1, which are adapted from parameters of MRF-132DG of Lord Corporation is far ahead of other MRF manufacturers, with reference to three types of MR fluids: MRF-122-ED (having a comparatively small yield stress), MRF-132DG (having a comparatively medium yield stress) and MRF-140CG (having a comparatively high yield stress).

TABLE 1
MRF-132DG Parameters

| Property | Value/limits |
|---|---|
| Base fluid | Hydrocarbons |
| Operating temperature | −40 to 130 (° C.) |
| Density | 3090 (kg/m³) |
| Color | Dark gray |
| Weight percent solid | 81.64(%) |
| Coefficient of thermal expansion (calculated values) | Unit volume per ° C. |
| 0-50 (° C.) | 5.5e−4 |
| 50-100 (° C.) | 6.6e−4 |
| 100-150 (° C.) | 6.7e−4 |
| Specific heat at 25 (° C.) | 800 (J/kg K) |
| Thermal conductivity at 25 (° C.) | 0.25-1.06 (W/mK) |
| Flash point | −150 (° C.) |
| Viscosity (slope between 800 and 0 Hz at 40 (° C.) | 0.09 (±0.02) Pa s |
| k | 0.269 (Pa m/A) |
| β | 1 |

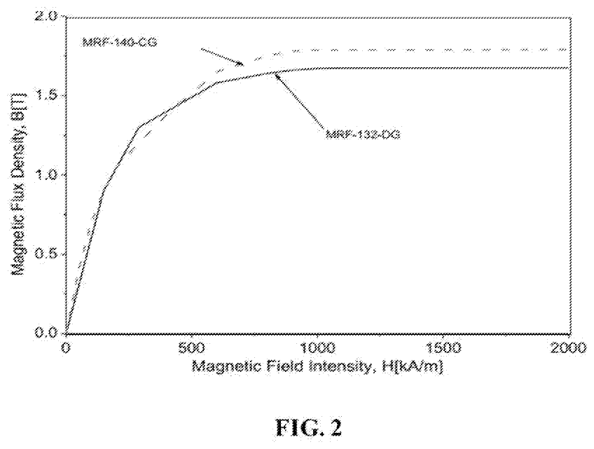

Further, the magnetic characteristic of MRF-132DG, wherefrom the parameters in Table 1 are adapted, is nonlinear and is defined by the B-H curve as shown in FIG. 2.

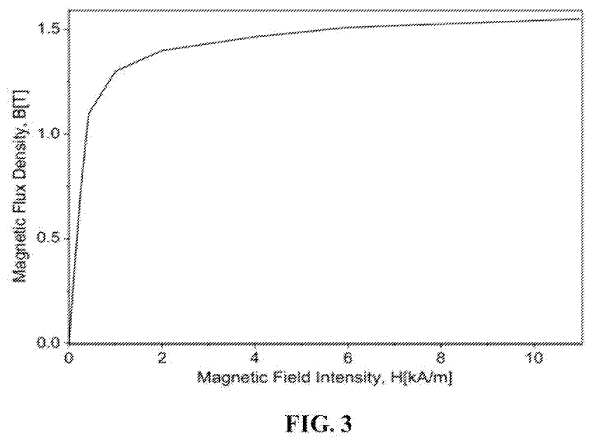

The selection of materials form forming the first plurality of annular structures 36 and the second plurality of annular structures 38, also known as brake material, is an important part of MR brake design and manufacturing. The brake material used in MR brake design and manufacture must meet working conditions and requirements for design, manufacture and common use in the market. Preferably, the brake material is carbon steel C45. C45 steel is widely used in engineering in general and machine building in particular because it is easy to process, has good magnetic conductivity, cheap and is readily available. C45 steel is a good quality steel with a carbon percentage of about 0.42-0.50%. In addition, the components of C45 steel (calculated by weight) are: C=0.4-0.5%; Si=0.17-0.37%; Mn=0.50-0.80%; Ni=0.3%; S=0.045%; P=0.045%; and Cr=0.3%. The magnetic properties of C45 steel are shown as a B-H curve in FIG. 3.

The MR brake assembly 20 can be segregated along a rotor plane 72 into a first portion accommodating the first plurality of annular structures 36, and a second portion accommodating the second plurality of annular structures 38. The rotor plane 72 extends along the plane of the rotor 26 and is substantially parallel the drive axis 24.

Each of the first portion and the second portion can contain one, two or three magnetic coils based on operating parameters and requirements for the MR brake assembly 20. This means that each of the at least one first magnetic coil 52 and each of the at least one second magnetic coil 54 can have a one, two or three coil configuration. Should there be more than one coil being implemented for each of the first portion 72 and the second portion, the multiple coils for each of the at least one first magnetic coil 52 and the at least one second magnetic coil 54 will be preferably configured in a concentric arrangement about the drive axis 24.

The brake housing 30 further comprises a first outer ring 80a and a second outer ring 80b having a shape and dimensions substantially similar to the first outer ring 80a. The first outer ring 80a abuts and couples to the second outer ring 80b for defining a recess for accommodating a portion of the outer periphery of the rotor 26.

The brake housing 30 further comprises a first brake plate 81a and a second brake plate 81b which are made of non-magnetic materials. The first brake plate 81a couples to and has an outer diameter that is smaller than the outer diameter of the first outer ring 80a. The second brake plate 81b couples to and has an outer diameter that is smaller than the outer diameter of the second outer ring 80b. The first outer ring 80a and the second outer ring 80b spatially displaces the first brake plate 81a and the second brake plate 81b away from the rotor 26.

The brake housing 30 further comprises a first inner ring 82a and a second inner ring 82b having a shape and dimensions substantially similar to the first inner ring 82a. The first brake plate 81a couples to and has an outer diameter that is larger than the outer diameter of the first inner ring 82a. The second brake plate 81b couples to and has an outer diameter that is larger than the outer diameter of the second inner ring 82b. The first brake plate 81a is nested with and radially interposes the first outer ring 80a and the second outer ring 82a. The second brake plate 81b is nested with and radially interposes the second outer ring 80b and the second inner ring 82b.

Each of the first inner ring 82a and the second inner ring 82b defines a corresponding one of the pair of apertures 64 and is shaped and dimensioned for accommodating one of the pair of seals 66 and one of a pair of bearings 84 positioned adjacent the corresponding one of the pair of apertures 64. The shaft 62 extends from the rotor 26 and out through the pair of apertures 64 via the pair of seals 66 and the pair of bearings 84.

The first brake plate 81a, the second brake plate 81b, the first outer ring 80a, second outer ring 80b, the first inner ring 82a and the second inner ring 82b are shaped and dimensioned for defining the chamber when inter-coupled and are inter-configured for defining the first fluid slot 68 and the second fluid slot 78 with the rotor 26. Preferably, the first fluid slot 68 fluid communicates with the second fluid slot 70. Further, the first brake plate 81a, the second brake plate 81b, the first outer ring 80a, second outer ring 80b, the first inner ring 82a and the second inner ring 82b are made from substantially non-magnetic material.

The first brake plate 81a defines one of the two inward faces 34 and first inward recesses for receiving the at least one of the first plurality of annular structures 36 one of formed therewith and coupled thereto. The second brake plate 81b defines the other of the two inward faces 34 and second inward recesses for receiving the at least one of the second plurality of annular structures 38 one of formed therewith and coupled thereto.

Preferably, the first brake plate 81a further defines first outward recesses 88a which outwardly opposes the first inwards recesses, while the second brake plate 81b further defines second outward recesses 88b which outwardly opposes the first inwards recesses.

The first outward recesses 88a are for accommodating the at least one first magnetic coil 52 therein while the second outward recesses 88b are for accommodating the at least one second magnetic coil 54 therein.

The brake housing 30 further comprises a first cover 90a shaped for coupling to and for covering one side of the first outer ring 80a for enclosing the at least one first magnetic coil 52 and to impeded access to the first brake plate 81a and the first inner ring 82a. The brake housing 30 further comprises a second cover 90b shaped for coupling to and for covering one side of the second outer ring 80b for enclosing the at least one second magnetic coil 54 and to impeded access to the second brake plate 81b and the second inner ring 82b. Each of the first cover 90a and the second cover 90b is an opening wherethrough a respective end of the shaft 62 extends.

When in use, the driven member 22 is coupled to machine or rotary system, preferably the output motion delivery means thereof such as an output transmission shaft or the wheels of a vehicle, where motion is to be impeded. Examples of such output motion delivery means include an output transmission shaft of a vehicle, the wheels of a vehicle or a manipulator or spindle of a machine. When motion is required, the rotor 26, and consequently the shaft 62 whereto the output of the machine is connected, rotates unimpeded as the quantity of MR fluid 42 as the rotor 26 will rotate through the quantity of MR fluid 42 without resistance therefrom.

Once motion of the rotor 26, and consequently the motion of the output motion delivery means, needs to be impeded, the magnetic field generation assembly 40 can be operated and controlled to selectively apply magnetic field to the quantity of MR fluid 42 via the at least one first magnetic coil 52 and the at least one second magnetic coil 54. The magnetic field from the at least one first magnetic coil 52 is shaped substantially along the first zig-zag flux lines 56 by the inter-configuration of the first plurality of annular structures 36 while the magnetic field from the at least one second magnetic coil 54 is shaped substantially along the second zig-zag flux lines 58 by the inter-configuration of the first plurality of annular structures 38. The magnetic field that is generated along and across the first fluid slot 68 and the second fluid slot 70, coalesces the quantity of MR fluid 42 therein to slow down or stop the rotor 26 that was in motion. Specifically, the magnetic field generated coalesces the quantity of MR fluid 42 to create a brake moment on the rotor 26 that slows down or stop the output motion delivery means which translates into slowing down or stopping of, for example, a vehicle that is being driven by the output motion delivery means. The magnitude of the braking moment is dependent on and a function of magnitude of amperage of electrical current being fed to the at least one first magnetic coil 52 and the at least one second magnetic coil 54.

Once the at least one first magnetic coil 52 and the at least one second magnetic coil 54, the magnetic field acting on the quantity of MR fluid 42 is absent and the brake moment is substantially reduced to enable rotation of the rotor 26 through the quantity of MR fluid 42 without resistance as the quantity of MR fluid 42 no longer coalesces due to the absence of magnetic field.

Depending on the strength of the magnetic field applied by the at least one first magnetic coil 52 and the at least one second magnetic coil 54, the extent that the quantity of MR fluid coalesces can be controlled which, in turn, controls the amount of motion resistance applied to the rotor 26. The magnetic field generation assembly 40 can further comprise a input device 92, for example a brake lever, a control know, a key-pad or a touch sensor that allows interaction with a user to control the amount of magnetic field to be applied to the quantity of MR fluid 42. Preferably, the magnetic field generation assembly 40 further comprises a controller 94 which inter-couples the input device 92 to each of the first magnetic coil 52 and the at least one second magnetic coil 54 and translates the user interaction with or manipulation of the input device 92 into varying levels or magnitude of current delivered each of the first magnetic coil 52 and the at least one second magnetic coil 54.

In an exemplary implementation of the MR brake assembly, each of the at least one first magnetic coil 52 and each of the at least one second magnetic coil 54 has a coil width (w_{c}) of 4 mm, a coil height (h_{c}) of 21 mm and preferably contains 235 coil turns. The rotor 26 preferably has a radius of 100 mm and a width of 8 mm with a mass of 1.54 kg to apply a brake torque of 10 Nm. The first outer ring 80a and the second outer ring 80b, when inter-coupled, has an outer radius of 132.4 mm and a width of 14.4 mm. Preferably, each of the first fluid slot 68 and the second fluid slot has a width/gap of 0.8 mm.

Aspects of particular embodiments of the present disclosure address at least one aspect, problem, limitation, and/or disadvantage associated with existing MR brake assemblies. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed structures, components, or alternatives thereof, can be desirably combined into alternative structures, components, and/or applications. In addition, various modifications, alterations, and/or improvements may be made to various embodiments that are disclosed by a person of ordinary skill in the art within the scope of the present disclosure, which is limited only by the following claims.

1. A magneto-rheological (MR) brake assembly comprising:
a driven member rotatable about a drive axis and comprising a rotor defining an outward face;
a brake housing defining a chamber being shaped and dimensioned for accommodating the rotor therein, the brake housing defining an inward face opposing the inward face of the rotor;
a plurality of annular structures, each of the plurality of annular structures having a medial diameter that differs from the medial diameter of another one of the plurality of annular structures, each of the rotor and the brake housing having at least one of the plurality of annular structures one of formed therewith and coupled thereto adjacent the corresponding one of the inward face and the outward face; and
a magnetic field generation assembly configured to selectively apply a magnetic field to a quantity of MR fluid disposable in the chamber for controlling engagement of the rotor with the brake housing to brake the driven member,
wherein each of the plurality of annular structures is made from magnetic material with the plurality of annular structures being spatially inter-displaced.

2. The MR brake assembly as in claim 1, one portion of the plurality of annular structures being arranged concentrically about the drive axis along the inward face of the brake housing while the other portion of the plurality of annular structures being arranged concentrically about the drive axis along the outward face of the rotor.

3. The MR brake assembly as in claim 1, each of the inward face and the outward face being substantially planar and perpendicular the drive axis.

4. The MR brake assembly as in claim 2, the brake housing comprising a disc spatially displaced from the one portion of the plurality of annular structures arranged along the inward face, the disc being dimensioned to be diametrically nearest to a diametrically largest one of the one portion of the plurality of annular structures arranged along the inward face,
wherein the disc is made from magnetic material.

5. The MR brake assembly as in claim 4, the brake housing further comprising a flange extending from the circumferential periphery of the disc and terminating adjacent the diametrically largest one of the one portion of the plurality of annular structures arranged along the inward face.

6. The MR brake assembly as in claim 4, the magnetic field generation assembly comprising at least one magnetic coil disposed between the disc and the one portion of the plurality of annular structures arranged along the inward face.

7. The MR brake assembly as in claim 4, the side planar cross-sectional position of the one portion of the plurality of annular structures along the inward face being radially staggered from the side planar cross-sectional position of the other portion of the plurality of annular structures along the outward face to define a zig-zag flux line therebetween, the side planar cross-section being defined along a plane parallel the drive axis.

8. The MR brake assembly as in claim 7, the quantity of MR fluid being a controllable medium having a rheology variable response to changes in magnetic field generated by the magnetic field generation assembly for controllably resisting rotation of the rotor about the drive axis.

9. The MR brake assembly as in claim 1, the driven member further comprising a shaft whereto the rotor is coupled, the shaft extending along the drive axis and out of a pair of apertures defined by the brake housing, wherein the brake housing comprising a pair of seals disposed adjacent the pair of apertures for fluid sealing the shaft with the brake housing.

10. The MR brake assembly as in claim 1, the magnetic material being C45 steel.

11. The MR brake assembly as in claim 2, the rotor being positioned within the chamber for defining a fluid slot between the inward face of the brake housing and the outward face of the rotor to enable the MR fluid in the chamber to interface the one portion of the plurality of annular structures and the other portion of the plurality of annular structures.

12. A magneto-rheological (MR) brake assembly comprising:
a driven member rotatable about a drive axis and comprising a rotor defining two outward faces;
a brake housing defining a chamber being shaped and dimensioned for accommodating the rotor therein, the brake housing defining two inward faces opposing the two inward faces of the rotor when the rotor is received within the chamber;
a first plurality of annular structures, each of the first plurality of annular structures having a medial diameter that differs from the medial diameter of another one of the first plurality of annular structures, each of one of the two outward faces and the corresponding one of the two inward faces having at least one of the first plurality of annular structures one of formed therewith and coupled thereto;
a second plurality of annular structures, each of the second plurality of annular structures having a medial diameter that differs from the medial diameter of another one of the second plurality of annular structures, each of the other of the two outward faces and the corresponding the other of the two inward faces having at least one of the second plurality of annular structures one of formed therewith and coupled thereto; and
a magnetic field generation assembly configured to selectively apply a magnetic field to a quantity of MR fluid disposable in the chamber for controlling engagement of the rotor with the brake housing to brake the driven member,
wherein each of the first plurality of annular structures and each of the second plurality of annular structures are made from magnetic material, the first plurality of annular structures being spatially inter-displaced and the second plurality of annular structures being spatially inter-displaced.

13. The MR brake assembly as in claim 12, one portion of each of the first plurality of annular structures and the second plurality of annular structures being arranged concentrically about the drive axis along the corresponding one of the two inward faces of the brake housing while the other portion of each of the first plurality of annular structures and the second plurality of annular structures being arranged concentrically about the drive axis along the corresponding one of the two outward faces of the rotor,
wherein each of the two inward faces and the two outward faces being substantially planar and perpendicular the drive axis.

14. The MR brake assembly as in claim 13, the brake housing comprising:
a first disc spatially displaced from the one portion of the first plurality of annular structures arranged along one of the two inward faces, the first disc being dimensioned to be diametrically nearest to a diametrically largest one of the one portion of the first plurality of annular structures arranged along the other of the two inward faces; and
a second disc spatially displaced from the one portion of the second plurality of annular structures arranged along the other of the two inward faces, the second disc being dimensioned to be diametrically nearest to a diametrically largest one of the one portion of the second plurality of annular structures arranged along the other of the two inwards face,
wherein each of the first disc and the second disc is made from magnetic material.

15. The MR brake assembly as in claim 14, the brake housing further comprising:
a first flange extending from the circumferential periphery of the first disc and terminating adjacent the diametrically largest one of the one portion of the first plurality of annular structures arranged along one of the two inward faces; and
a second flange extending from the circumferential periphery of the second disc and terminating adjacent the diametrically largest one of the one portion of the second plurality of annular structures arranged along the other of the two inward faces.

16. The MR brake assembly as in claim 14, the magnetic field generation assembly comprising:
at least one first magnetic coil disposed between the first disc and the one portion of the first plurality of annular structures arranged along one of the two inward faces; and
at least one second magnetic coil disposed between the second disc and the one portion of the second plurality of annular structures arranged along the other of the two inward faces.

17. The MR brake assembly as in claim 14, the side planar cross-sectional position of the one portion of the first plurality of annular structures along one of the two inward faces being radially staggered from the side planar cross-sectional position of the other portion of the first plurality of annular structures along one of the two outward faces to define a first zig-zag flux line therebetween, and the side planar cross-sectional position of the one portion of the second plurality of annular structures along the other of the two inward faces being radially staggered from the side planar cross-sectional position of the other portion of the second plurality of annular structures along the other of the two outward faces to define a second zig-zag flux line therebetween,
wherein the side planar cross-section being defined along a plane parallel the drive axis, and the quantity of MR fluid being a controllable medium having a rheology variable response to changes in magnetic field generated by the magnetic field generation assembly for controllably resisting rotation of the rotor about the drive axis.

18. The MR brake assembly as in claim 12, the driven member further comprising a shaft whereto the rotor is coupled, the shaft extending along the drive axis and out of a pair of apertures defined by the brake housing, wherein the brake housing comprising a pair of seals disposed adjacent the pair of apertures for fluid sealing the shaft with the brake housing,
wherein the magnetic material being C45 steel.

19. The MR brake assembly as in claim 13, the rotor being positioned within the chamber for defining a first fluid slot between one of the two inward faces of the brake housing and one of the two outward faces of the rotor, and a second fluid slot between the other of the two inward faces of the brake housing and the other of the two outward faces of the rotor to thereby enable the MR fluid in the chamber to interface the one portion of the first plurality of annular structures and the other portion of the first plurality of annular structures and to interface the one portion of the second plurality of annular structures and the other portion of the second plurality of annular structures respectively.
